(19) United States
(12) Patent Application Publication
(10) Pub. No.: US 2023/0174375 A1
(43) Pub. Date: Jun. 8, 2023

(54) AMMONIA CRACKING PROCESS AND APPARATUS FOR IMPROVED HYDROGEN RECOVERY

(71) Applicant: UOP LLC, Des Plaines, IL (US)

(72) Inventor: Bradley Russell, Fall Branch, TN (US)

(21) Appl. No.: 17/818,498

(22) Filed: Aug. 9, 2022

Related U.S. Application Data
(60) Provisional application No. 63/264,974, filed on Dec. 6, 2021.

(51) Int. Cl. C01B 3/04; C01B 3/50; C01B 3/52

(52) U.S. Cl. CPC C01B 3/047; C01B 3/52; C01B 3/508; B01D 2256/16; B01D 2259/40022; C01B 2203/043; C01B 2203/146; C01B 2203/0266; C01B 2203/0415; C01B 2203/0827

(57) ABSTRACT

Methods for producing hydrogen from ammonia are described. The methods involve the use of a two-stage hydrogen PSA configuration. The effluent stream from the ammonia cracking reaction zone is sent to the first hydrogen PSA unit where it is separated into a high purity, high-pressure hydrogen stream and a low-pressure tail gas stream. The high-pressure hydrogen stream can be recovered. The low-pressure tail gas stream is compressed and sent to the second hydrogen PSA unit where it is separated into a second high-pressure stream and a second low-pressure tail gas stream. The second high-pressure hydrogen stream can be recycled to the first hydrogen PSA unit for further separation.

### RELATED APPLICATIONS

This application claims priority to U.S. Provisional Pat. Application Ser. No. 63/264,974, filed on Dec. 6, 2021, the entirety of which is incorporated herein by reference.

### BACKGROUND

Ammonia can be used as a liquid hydrogen carrier with the existing transportation infrastructure. If the carbon dioxide by-product from a fossil-fuel based ammonia production process is recovered and sequestered (Blue Ammonia), the resulting hydrogen has a low carbon footprint. At the point of use, the Blue Ammonia is cracked at high temperature (e.g., about 850° C.) into H2 and N2 according to the following endothermic equilibrium reaction: 2NH₃ = N₂ +3H₂

The resulting product mixture (75 mol% H₂ and 25 mol% N₂) is then separated in a pressure swing adsorption (PSA) unit to recover high-purity hydrogen.

Some prior art methods involve the use of a single PSA unit. Some current small-scale ammonia cracking furnaces use electric heaters, and the PSA tail gas provides additional heat to drive the process.

Other prior art methods use a two-stage configuration in which a PSA unit is followed by a membrane separator on the tail gas stream from the PSA unit. One disadvantage of the two-stage design with a membrane is that additional compression is required on the membrane permeate in order to recycle the permeate back to the PSA feed. This results in a high overall specific compression power requirement and the need for an additional compressor for the permeate.

Therefore, there is a need for processes to improve point-of-use separation efficiency and to reduce the net cost of hydrogen recovery.

### BRIEF DESCRIPTION OF THE DRAWINGS

FIG. 1 is an illustration of one embodiment of a process according to the present invention with a single PSA unit.

FIG. 2 is an illustration of a second embodiment of a process according to the present invention with two PSA units.

FIG. 3 is a graph comparing the compression power v. % heat duty from burning hydrogen for the processes of FIGS. 1 and 2.

FIG. 4 is a graph comparing hydrogen production v. % heat duty from burning hydrogen for the processes of FIGS. 1 and 2.

### DESRCIPTION OF THE INVENTION

This invention disclosure addresses this need by using a single PSA unit with partial tail gas recycle or a two-stage PSA configuration to minimize specific compression power (kW hr/MT H₂) in the separation section of the ammonia cracking process.

The process involves the use of a single PSA unit with partial tail gas recycle or two hydrogen PSA units in series. In the single PSA unit with partial tail gas recycle, the cracked effluent stream from the ammonia cracking reaction zone is sent to the hydrogen PSA unit either directly or following a water washing in a water wash vessel. The temperature of the effluent stream entering the hydrogen PSA unit is about 30-50° C. The cracked effluent stream is separated into a high purity, high-pressure hydrogen stream and a low-pressure tail gas stream. The high-pressure hydrogen stream can be recovered. The low-pressure tail gas stream is compressed and sent to the hydrogen PSA unit, either directly or to the water wash vessel first (if present).

The high-pressure hydrogen stream typically comprises greater than 99.0 mol% hydrogen, or greater than 99.9 mol% hydrogen, or greater than 99.97 mol% hydrogen. The low-pressure tail gas stream typically comprises 50 mol% to 70 mol% nitrogen, with the balance being hydrogen (i.e., 30 mol% to 50 mol% hydrogen) on a dry basis.

The pressure of the high-pressure hydrogen stream is typically in the range of 2000 kPa to 6000 kPa, or 2000 kPa to 5000 kPa, or 2000 kPa to 4000 kPa, or 2000 kPa to 3000 kPa.

The pressure of the low-pressure tail gas stream is typically in the range of 100 kPa to 300 kPa, or 100 kPa to 200 kPa.

In the two-stage PSA configuration, the cracked effluent stream from the ammonia cracking reaction zone is sent to the first hydrogen PSA unit either directly or following a water washing in a water wash vessel. The cracked effluent stream is separated into a high purity, high-pressure hydrogen stream and a low-pressure tail gas stream. The high-pressure hydrogen stream can be recovered. The low-pressure tail gas stream is compressed and sent to the second hydrogen PSA unit where it is separated into a second high-pressure hydrogen stream and a second low-pressure tail gas stream. The second low-pressure tail gas stream can be recovered for use a fuel gas for the ammonia cracking reactor or elsewhere in the plant. The second high-pressure hydrogen stream can be sent back to the first hydrogen PSA unit, either directly or to the water wash vessel first, for further separation. Alternatively, it could be recovered and optionally further processed to purify the stream if needed. The first high pressure hydrogen stream and the first low pressure tail gas stream are as described above for the single PSA unit. The second high pressure hydrogen stream typically comprises about 60 mol% to 90 mol% hydrogen and about 10 mol% to 40 mol% nitrogen. The second low pressure tail gas stream typically comprises 70 mol% to 90 mol% nitrogen, with the balance being hydrogen (i.e., 10 mol% to 30 mol% hydrogen) on a dry basis.

The two-stage hydrogen PSA design provides lower specific compression power compared to a single hydrogen PSA unit. For the same hydrogen recovery, the compression power is lower for the two stage design. Looked at another way, for the same compression power, the hydrogen recovery is greater for the two stage design. This is especially true at lower fuel-gas duties (higher electric heating duty), where H₂ product recovery is higher.

The high-pressure hydrogen stream from the second hydrogen PSA unit could be recovered and optionally further treated to purify the stream if needed. Alternatively, it can be recycled to the first hydrogen PSA unit.

The fuel bleed stream from the first low-pressure tail gas stream can be adjusted to meet a desired heating duty for the ammonia cracking reaction zone. In addition, the hydrogen recovery from the second hydrogen PSA unit can be adjusted in order to provide a desired amount of fuel gas for the ammonia cracking reaction zone.

The single stage PSA arrangement would be preferred if it is desired to provide a large fraction of heating duty from burning hydrogen and minimize electrical or auxiliary fuel heating duty. In this case, the single stage PSA arrangement would provide lower capital cost and about the same operating cost. The two stage PSA arrangement would be preferable if the goal is to maximize hydrogen recovery and provide more heating duty from electricity or auxiliary fuel.

The hydrogen PSA units are conventional PSA units. For example, they could be six bed PSA units with three pressure equalization steps (a 6-1-3 cycle). The minimum number of beds would be four and the maximum could be ten or more.

The hydrogen PSA units contain adsorbent layers to remove water, ammonia, and nitrogen. Water will be present when the process includes a water wash vessel. Any suitable adsorbents can be used. Suitable adsorbents for nitrogen adsorption can be a molecular sieve zeolite, including, but not limited to, CaA, NaX, CaX, or LiX. Suitable adsorbents for water and ammonia include, but are not limited to silica gel, activated alumina, or activated carbon.

The hydrogen recovery from the ammonia cracking effluent is typically in the range of 80% to 98%.

The low pressure tail gas from the first and second hydrogen PSA typically supplies 10% to 90% of the heat duty for the ammonia cracking process, with the remainder supplied by electrical heating or an auxiliary fuel.

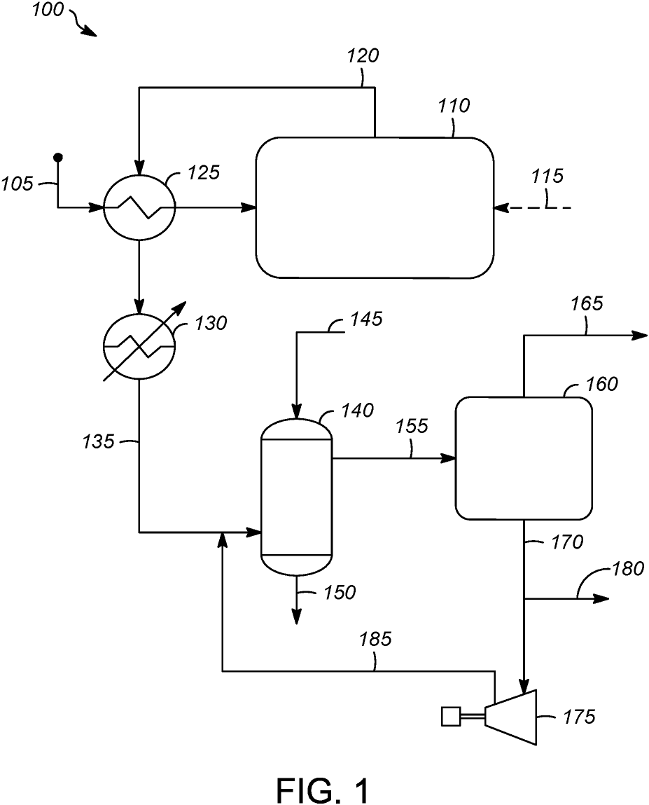

FIG. 1 illustrates an ammonia cracking process 100 having a single hydrogen PSA unit with partial tail-gas recycle. The ammonia feed stream 105 comprising ammonia is sent to an ammonia cracking reaction zone 110. The ammonia cracking reaction zone 110 can be any suitable ammonia cracking zone. It can include an ammonia cracking reactor and associated equipment, such as a furnace with one or more burners, electric heaters, heat exchangers, etc. Suitable ammonia cracking zones are well-known to those of skill in the art.

Heat is input into the ammonia cracking reaction zone 110 using a heat source 115. The effluent stream 120 from the ammonia cracking reaction zone 110 comprises a mixture of H₂ and N₂, and it is typically at a temperature in the range of 700 to 1000° C.

The effluent stream 120 from the ammonia cracking reaction zone 110 is heat exchanged with the ammonia feed stream 105 in heat exchanger 125. It can be further cooled in an optional second cooler 130.

The cooled effluent stream 135 may be introduced into an optional water wash vessel 140. A clean water stream 145 is introduced into the water wash vessel 140 to remove residual unreacted ammonia, and the spent water stream 150 containing ammonia is removed from the water wash vessel 140.

The washed effluent stream 155 is sent to the hydrogen PSA unit 160 where it is separated into a high purity, high-pressure hydrogen stream 165 and a low-pressure tail gas stream 170. The low-pressure tail gas stream 170 is sent to a compressor 175. The pressure of the high-pressure hydrogen stream 165 is in the range of about 2000 to 6000 kPa, while the pressure of the low-pressure tail gas stream is about 100 to 300 kPa. The temperature of the washed effluent stream 155 is about 30-50° C. entering the first hydrogen PSA unit.

A slip stream 180 from the low-pressure tail gas stream 170 may be removed to prevent the build-up of nitrogen.

The compressed tail gas stream 185 may be recycled to the water wash vessel 140.

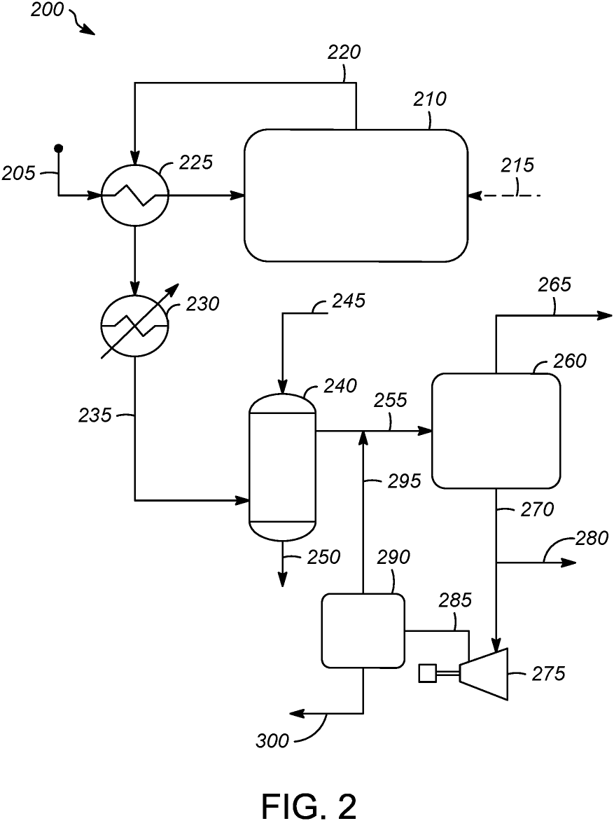

However, this scheme leads to higher specific compression power compared to the two-stage process 200 illustrated in FIG. 2. The ammonia feed stream 205 is sent to the ammonia cracking reaction zone 210. The ammonia cracking reaction zone 210 can be any suitable ammonia cracking zone, as discussed above.

Heat is input into the ammonia cracking reaction zone 210 using a heat source 215. The effluent stream 220 from the ammonia cracking reaction zone 210 is heat exchanged with the ammonia feed stream 205 in heat exchanger 225. It can be further cooled in an optional second cooler 230.

The cooled effluent stream 235 may be introduced into an optional water wash vessel 240. A clean water stream 245 is introduced into the water wash vessel 240, and the spent water stream 250 is removed from the water wash vessel 240.

The washed effluent stream 255 is sent to the first hydrogen PSA unit 260 where it is separated into a high purity, high-pressure hydrogen stream 265 and a low-pressure tail gas stream 270. The temperatures and pressures for the first hydrogen PSA unit 260 are the same as those described above.

The low-pressure tail gas stream 270 is sent to a compressor 275. A slip stream 280 from the low-pressure tail gas stream 270 may be removed

The compressed tail gas stream 285 is sent to a second hydrogen PSA unit 290 where it is separated into a second high-pressure hydrogen stream 295 and a tail gas stream 300. The tail gas stream 300 can be used as fuel, for example. It could provide at least a portion of the fuel for the heat source 215.

The second high-pressure hydrogen stream 295 can be sent back to the first hydrogen PSA unit 260.

### Example

A comparison was made between a single PSA design with partial tail gas recycle according to the present invention as shown in FIG. 1 and one embodiment of a two-stage PSA configuration according to the present invention as shown in FIG. 2. A computer simulation was constructed of an ammonia cracking process with these two separation schemes for a fixed ammonia feed rate of 185 MT/day. In the single PSA design, fuel gas is taken as a slipstream upstream of the tail gas compressor.

This fuel gas provides a portion of the overall heat duty for the cracking process with the balance coming from an electric heater in the cracking furnace.

The two-stage scheme adds a second PSA unit on the compressed tail gas, with the overhead gas recycled back to the first PSA feed. Fuel gas is taken as a slipstream from the first PSA tail gas stream and is combined with the tail gas from the second PSA unit.

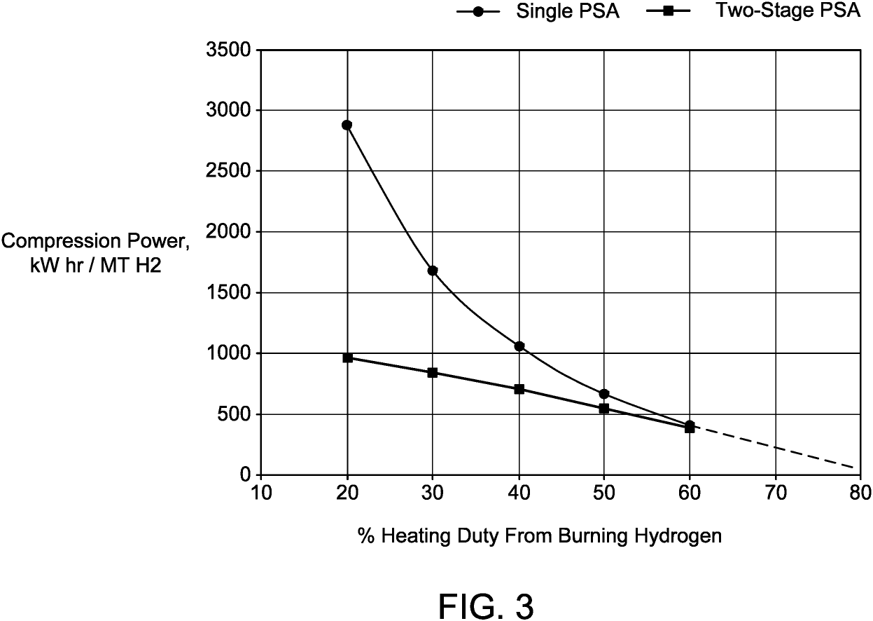

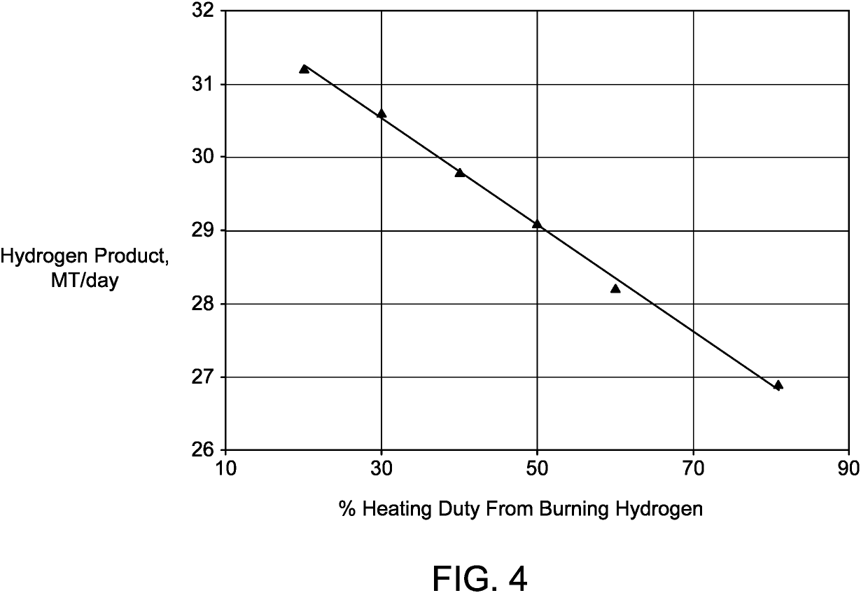

The simulation results are shown in FIGS. 3-4. For any given fuel-gas heating duty, the two-stage design provides lower specific compression power compared to a single PSA. This is especially true at lower fuel-gas duties (higher electric heating duty), where H₂ product recovery is higher.

### SPECIFIC EMBODIMENTS

While the following is described in conjunction with specific embodiments, it will be understood that this description is intended to illustrate and not limit the scope of the preceding description and the appended claims.

A first embodiment of the invention is a method of producing hydrogen from ammonia comprising; cracking an ammonia feed stream comprising ammonia in an ammonia cracking reaction zone to produce a cracked effluent stream comprising hydrogen and nitrogen; separating the cracked effluent stream in a first hydrogen pressure swing adsorption (PSA) unit into a first high-pressure hydrogen stream and a first hydrogen depleted tail gas stream comprising a portion of the hydrogen and the nitrogen; compressing the first hydrogen depleted low-pressure tail gas stream in a compressor to form a compressed tail gas stream; recycling at least a portion of the compressed tail gas stream to the first hydrogen PSA unit; and recovering the first high-pressure hydrogen stream. An embodiment of the invention is one, any or all of prior embodiments in this paragraph up through the first embodiment in this paragraph further comprising separating the compressed tail gas stream in a second hydrogen PSA unit into a second high-pressure hydrogen stream and a second hydrogen depleted tail gas stream comprising a portion of the hydrogen and the nitrogen before recycling the at least a portion of the compressed tail gas stream to the first hydrogen PSA unit. An embodiment of the invention is one, any or all of prior embodiments in this paragraph up through the first embodiment in this paragraph further comprising dividing the first hydrogen depleted tail gas stream into a first portion and a second portion; removing the first portion of the first hydrogen depleted low-pressure tail gas stream to remove nitrogen; and wherein compressing the first hydrogen depleted low-pressure tail gas stream in the compressor comprises compressing the second portion of the first hydrogen depleted low-pressure tail gas stream. An embodiment of the invention is one, any or all of prior embodiments in this paragraph up through the first embodiment in this paragraph wherein recycling at least the portion of the compressed tail gas stream to the first hydrogen PSA unit comprises recycling the second high-pressure hydrogen stream to the first hydrogen PSA unit. An embodiment of the invention is one, any or all of prior embodiments in this paragraph up through the first embodiment in this paragraph further comprising recovering the second high-pressure hydrogen stream. An embodiment of the invention is one, any or all of prior embodiments in this paragraph up through the first embodiment in this paragraph further comprising water washing the cracked effluent stream in a water washing vessel to remove ammonia before separating the cracked effluent stream. An embodiment of the invention is one, any or all of prior embodiments in this paragraph up through the first embodiment in this paragraph further comprising recycling the at least the portion of the compressed tail gas stream to the water washing vessel. An embodiment of the invention is one, any or all of prior embodiments in this paragraph up through the first embodiment in this paragraph further comprising combusting at least a portion of the first hydrogen depleted tail gas stream as a heat source for the ammonia cracking reaction zone. An embodiment of the invention is one, any or all of prior embodiments in this paragraph up through the first embodiment in this paragraph further comprising combusting at least a portion of the second hydrogen depleted tail gas stream as a heat source for the ammonia cracking reaction zone. An embodiment of the invention is one, any or all of prior embodiments in this paragraph up through the first embodiment in this paragraph wherein the first hydrogen depleted tail gas stream further comprises ammonia. An embodiment of the invention is one, any or all of prior embodiments in this paragraph up through the first embodiment in this paragraph wherein the second hydrogen depleted low-pressure tail gas stream further comprises ammonia. An embodiment of the invention is one, any or all of prior embodiments in this paragraph up through the first embodiment in this paragraph further comprising pre-heating the ammonia feed stream with the cracked effluent stream. An embodiment of the invention is one, any or all of prior embodiments in this paragraph up through the first embodiment in this paragraph wherein the first high-pressure hydrogen stream has a pressure in a range of 2000 kPa to 6000 kPa; and the first hydrogen depleted tail gas stream has a pressure in a range of 100 kPa to 300 kPa. An embodiment of the invention is one, any or all of prior embodiments in this paragraph up through the first embodiment in this paragraph wherein the second high-pressure hydrogen stream has a pressure in a range of 2000 kPa to 6000 kPa; and the second hydrogen depleted low-pressure tail gas stream has a pressure in a range of 100 kPa to 300 kPa. An embodiment of the invention is one, any or all of prior embodiments in this paragraph up through the first embodiment in this paragraph wherein a temperature of the cracked effluent stream entering the first PSA unit is in a range of about 30° C. to 50° C. An embodiment of the invention is one, any or all of prior embodiments in this paragraph up through the first embodiment in this paragraph wherein combusting the first hydrogen depleted tail gas stream and the second hydrogen depleted tail gas stream as a heat source for the ammonia cracking reaction zone provides 10% to 90% of a heat duty for the ammonia cracking reaction zone. An embodiment of the invention is one, any or all of prior embodiments in this paragraph up through the first embodiment in this paragraph wherein hydrogen recovery from the cracked effluent stream is in a range of 80% to 98%.

A second embodiment of the invention is an apparatus for producing hydrogen from ammonia comprising an ammonia cracking reaction zone having an inlet and an outlet, a first PSA unit having an inlet, a high-pressure hydrogen outlet, and a low pressure tail gas outlet, the outlet of the ammonia cracking reactor in fluid communication with the inlet of the first PSA unit; a compressor having an inlet and an outlet, the compressor inlet in fluid communication with the low-pressure tail gas outlet of the first PSA unit, and the compressor outlet in fluid communication with the inlet of the first PSA unit. An embodiment of the invention is one, any or all of prior embodiments in this paragraph up through the second embodiment in this paragraph further comprising a second PSA unit having an inlet, a high pressure hydrogen outlet, and a low pressure tail gas outlet, the inlet of the second PSA unit in fluid communication with the compressor outlet. An embodiment of the invention is one, any or all of prior embodiments in this paragraph up through the second embodiment in this paragraph wherein the high pressure hydrogen outlet of the second PSA unit is in fluid communication with the inlet of the first PSA unit.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A method of producing hydrogen from ammonia comprising;
cracking an ammonia feed stream comprising ammonia in an ammonia cracking reaction zone to produce a cracked effluent stream comprising hydrogen and nitrogen;
separating the cracked effluent stream in a first hydrogen pressure swing adsorption (PSA) unit into a first high-pressure hydrogen stream and a first hydrogen depleted tail gas stream comprising a portion of the hydrogen and the nitrogen;
compressing the first hydrogen depleted low-pressure tail gas stream in a compressor to form a compressed tail gas stream;
recycling at least a portion of the compressed tail gas stream to the first hydrogen PSA unit; and
recovering the first high-pressure hydrogen stream.

2. The method of claim 1 further comprising:
separating the compressed tail gas stream in a second hydrogen PSA unit into a second high-pressure hydrogen stream and a second hydrogen depleted tail gas stream comprising a portion of the hydrogen and the nitrogen before recycling the at least a portion of the compressed tail gas stream to the first hydrogen PSA unit.

3. The method of claim 1 further comprising:
dividing the first hydrogen depleted tail gas stream into a first portion and a second portion;
removing the first portion of the first hydrogen depleted low-pressure tail gas stream to remove nitrogen; and
wherein compressing the first hydrogen depleted low-pressure tail gas stream in the compressor comprises compressing the second portion of the first hydrogen depleted low-pressure tail gas stream.

4. The method of claim 2 wherein recycling at least the portion of the compressed tail gas stream to the first hydrogen PSA unit comprises recycling the second high-pressure hydrogen stream to the first hydrogen PSA unit.

5. The method of claim 2 further comprising:
recovering the second high-pressure hydrogen stream.

6. The method of claim 1 further comprising:
water washing the cracked effluent stream in a water washing vessel to remove ammonia before separating the cracked effluent stream.

7. The method of claim 6 further comprising:
recycling the at least the portion of the compressed tail gas stream to the water washing vessel.

8. The method of claim 1 further comprising:
combusting at least a portion of the first hydrogen depleted tail gas stream as a heat source for the ammonia cracking reaction zone.

9. The method of claim 2 further comprising:
combusting at least a portion of the second hydrogen depleted tail gas stream as a heat source for the ammonia cracking reaction zone.

10. The method of claim 1 wherein the first hydrogen depleted tail gas stream further comprises ammonia.

11. The method of claim 2 wherein the second hydrogen depleted low-pressure tail gas stream further comprises ammonia.

12. The method of claim 1 further comprising:
pre-heating the ammonia feed stream with the cracked effluent stream.

13. The method of claim 1 wherein:
the first high-pressure hydrogen stream has a pressure in a range of 2000 kPa to 6000 kPa; and the first hydrogen depleted tail gas stream has a pressure in a range of 100 kPa to 300 kPa.

14. The method of claim 2 wherein:
the second high-pressure hydrogen stream has a pressure in a range of 2000 kPa to 6000 kPa; and the second hydrogen depleted low-pressure tail gas stream has a pressure in a range of 100 kPa to 300 kPa.

15. The method of claim 1 wherein a temperature of the cracked effluent stream entering the first PSA unit is in a range of about 30° C. to 50° C.

16. The method of claim 2 wherein combusting the first hydrogen depleted tail gas stream and the second hydrogen depleted tail gas stream as a heat source for the ammonia cracking reaction zone provides 10% to 90% of a heat duty for the ammonia cracking reaction zone.

17. The method of claim 1 wherein hydrogen recovery from the cracked effluent stream is in a range of 80% to 98%.

18. An apparatus for producing hydrogen from ammonia comprising:
an ammonia cracking reaction zone having an inlet and an outlet,
a first PSA unit having an inlet, a high-pressure hydrogen outlet, and a low pressure tail gas outlet, the outlet of the ammonia cracking reactor in fluid communication with the inlet of the first PSA unit; and
a compressor having an inlet and an outlet, the compressor inlet in fluid communication with the low-pressure tail gas outlet of the first PSA unit, and the compressor outlet in fluid communication with the inlet of the first PSA unit.

19. The apparatus of claim 18 further comprising:
a second PSA unit having an inlet, a high pressure hydrogen outlet, and a low pressure tail gas outlet, the inlet of the second PSA unit in fluid communication with the compressor outlet.

20. The apparatus of claim 19 wherein the high pressure hydrogen outlet of the second PSA unit is in fluid communication with the inlet of the first PSA unit.
